(19) United States
(12) Patent Application Publication
(10) Pub. No.: US 2015/0027964 A1
(43) Pub. Date: Jan. 29, 2015

(54) SEWAGE SCREENING SYSTEM

(71) Applicant: Anglian Water Services Limited, Huntingdon, Cambridgeshire (GB)

(72) Inventor: Frederick James Davis, Peterborough (GB)

(21) Appl. No.: 14/380,231

(22) PCT Filed: Feb. 21, 2013
(86) PCT No.: PCT/GB2013/050426

§ 371 Date: Aug. 21, 2014

(30) Foreign Application Priority Data
Feb. 22, 2012 (GB) 1203092.0

(51) Int. Cl. E03F 5/14; B01D 33/41; B01D 21/00; B01D 35/027

(52) U.S. Cl. CPC E03F 5/14; B01D 35/027; B01D 33/41; B01D 21/0012
USPC 210/804; 210/155; 210/162; 210/160; 210/324; 210/513

(57) ABSTRACT

A screening system comprises a tank (20) containing a sewage screen (30), wherein the tank is configured for attachment to a sewage channel, and to receive sewage flow from an upstream point of the channel, and then to direct the sewage flow through the sewage screen (30), and then to return the screened sewage flow back into the channel, at a downstream point, or directly to a downstream treatment, and wherein the tank (20) is configured to decrease the velocity of the sewage flow in the tank relative to the channel, such that grit can settle at the bottom of the tank, and wherein the sewage screen (30) comprises a working screening surface (31), a portion of which lies in a substantially horizontal plane, and is positioned below the invert level of the sewage channel at the upstream point, when in use. Screen and tank used within the before mentioned system as well as the method of screening sewage using the system are also disclosed.

### FIELD OF THE INVENTION

The present invention relates to sewage screens, and tanks containing sewage screens, which can be attached to a sewage channel.

### BACKGROUND

Sewage flow contains grit and screenings. Screenings comprise a variety of materials, such as rag, polystyrenes, plastics, fat, vegetable waste and other solid matter. There exists a dilemma whether to remove the grit or the screenings first

To remove the screenings first, it is necessary that the grit enters the screenings removal equipment, and the grit frequently causes significant wear to the moving parts, and occasionally causes failure of the component.

Alternatively, removal of the grit first requires a separation process, usually utilising relative density to settle the grit, preferably in a tank. However, this causes some screenings also to be deposited into the tank. They can wrap and bind with the grit and it is difficult, and sometimes hazardous, to dislodge or remove.

Another problem with screens, especially those that become clogged with screenings, is hydraulic loss across the screen. This can cause an increase in water level on the upstream side of the screen, posing problems in controlling premature discharge of untreated sewage to the receiving watercourse or flooding from the upstream system.

Further, sewage normally enters screening removals equipment at a higher velocity, which can cause damage to the equipment. Another disadvantage is that the throughput of conventional equipment is low.

EP1075865 describes apparatus for use in a sewage treatment plant, which is a tank containing a screen. This system can simultaneously settle grit and remove screenings, but it has drawbacks. The screen disclosed in this publication is a vertical conveyor screen, often this type is referred to as a Bandscreen. This system suffers from hydraulic loss, as discussed above, and the system described is not widely used commercially due to its overall cost.

In general, Bandscreens suffer from the problem of debris not lifted by the internal tines being left trapped inside the inlet working area. This debris can clog the inlet but also tumbles and eventually causes detriment to the working surface. Debris trapped can necessitate manual entry into the raw sewage area to clear, posing Health & Safety risks. Due to operational and maintainability difficulties, Bandscreens are not nowadays a primary choice within the industry, but can provide a working solution in some cases.

### SUMMARY OF THE INVENTION

The present invention is a system for simultaneously removing grit and screenings, and it provides a solution to the hydraulic loss problems suffered by the systems of the prior art. Using the screening system of the invention, the component parts are unlikely to be damaged by the screenings or the grit, and the grit is not contaminated with screenings. The present invention also has the advantage of minimal hydraulic loss, higher sewage throughput and relatively low internal flow velocity, which minimises damage to equipment.

One very important feature of the invention is that it is a simple design and has very low balance of plant when compared to the screening/grit removal equipment that is currently used. This means that the system of the invention has a low carbon footprint and has the potential to save energy and reduce the impact on the environment.

According to a first aspect, a screening system comprises a tank (20) containing a sewage screen, wherein the tank is configured for attachment to a sewage channel, and to receive sewage flow from an upstream point of the channel, and then to direct the sewage flow through the sewage screen, and then to return the screened sewage flow back into the channel, at a downstream point, or directly to a downstream treatment, and wherein the tank is configured to decrease the velocity of the sewage flow in the tank relative to the channel, such that grit can settle at the bottom of the tank, and wherein the sewage screen comprises a working screening surface (31), a portion of which lies in a substantially horizontal plane, and is positioned below the invert level of the sewage channel at the upstream point, when in use.

According to a second aspect, a sewage screen suitable for use in a screening system, comprises means for inducing and controlling a conveyor movement of the screen, and which comprises a plurality of screening zones, wherein each screening zone has a different screening function.

According to a third aspect, a tank, suitable for use in a system of the invention, is configured for attachment to a sewage channel, and configured to receive sewage flow from an upstream point of the channel, and then to return the sewage flow back into the channel, at a downstream point, wherein the tank is configured to decrease the velocity of the sewage flow in the tank relative to the channel, such that grit can settle at the bottom of the tank, and wherein the tank is configured such that sewage flows in at least two substantially opposite directions inside the tank.

According to a fourth aspect, a method of screening sewage that flows in a sewage channel, comprises diverting the sewage flow from the channel into a tank or system, which is configured such that the velocity of the sewage flow is lowered and grit can settle at the bottom of the tank, wherein large particulate matter is removed by a screen situated in the tank, wherein at least part of the screening surface of the screen is in a substantially horizontal plane and positioned below the invert level of the sewage channel.

### BRIEF DESCRIPTION OF THE FIGURES

FIG. 1 is a side elevated view of a system of the invention showing a “single pass”.

FIG. 2 is a schematic showing a possible flow path in a system of the invention.

FIG. 3 is a schematic showing an alternative flow path in a system of the invention.

FIG. 4 is a side view cross-section of a system of the invention through the internal screen.

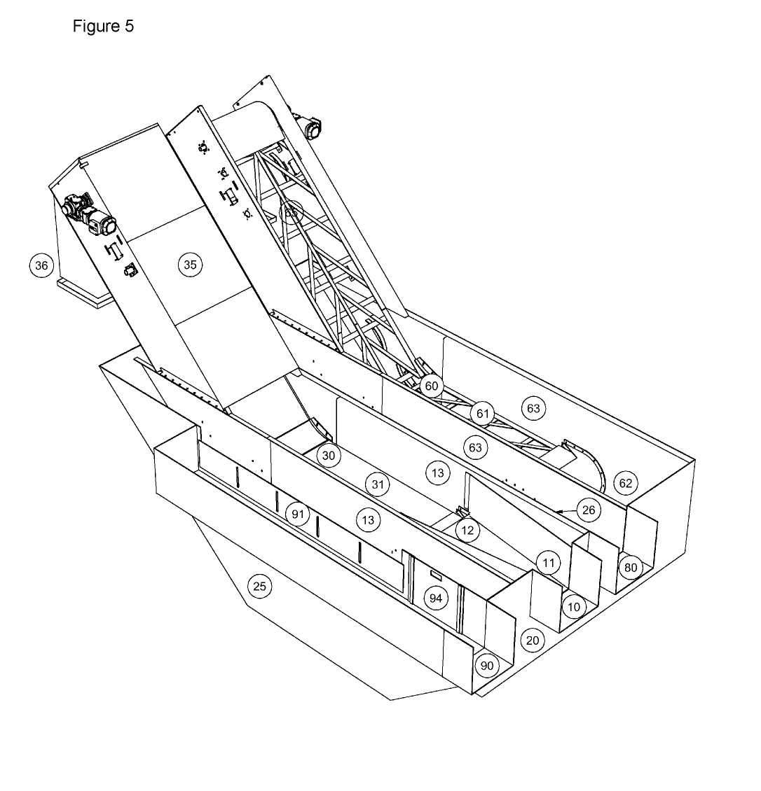

FIG. 5 is an isometric view of a system of the invention which contacts two screens in a “two-pass” arrangement.

FIG. 6 is a schematic showing a flow path through a “two-pass” system.

FIG. 7 is an isometric view of a two-pass arrangement in a system containing a single screen.

FIG. 8 is a screen according to the invention, having a plurality of screening zones.

### DESCRIPTION OF THE PREFERRED EMBODIMENTS

A sewage screen according to the invention comprises a working screening surface, i.e. a part that performs the screening function. At least part of that screening surface is positioned below the invert level of the channel, in use, and lies in a substantially horizontal plane. Preferably, it lies in a horizontal plane. It will be appreciated that the surface may contain flights, for example, which are positioned at an angle to the surface, but it is the overall longitudinal surface of the screen that lies in the horizontal plane. If the screen were positioned vertically, the flow direction would be perpendicular to the screening surface/screen curtain. In the invention, there is portion that lies in the horizontal plane, i.e. a portion which lies in a plane that is parallel to the direction of flow. In context, horizontal means that it is substantially parallel to the surface or direction of the sewage flow, in use.

Preferably, a system of the invention is configured to receive sewage flow from a sewage channel, to screen the sewage, and to return it to the sewage channel, at a downstream point. However, a system of the invention may be configured to receive sewage flow from a sewage channel, to screen the sewage, and then to exit the flow to another point, such as downstream treatment.

Sewage screens are well known in the art, as are sewage screens capable of conveyor movement. A sewage screen filters raw sewage, leaving a residue of solid “screenings” on the upstream side of the screen, and allowing a filtrate, which contains non-particulate matter. Conveyor movement of a screen can serve to remove the screenings from the sewage flow, allowing them to be disposed of safely, and decreasing the hydraulic loss that can occur due to a blocked screen. Preferably, a screen of the invention is a conveyor screen.

A sewage screen for use in a system of the invention preferably comprises a plurality of screening zones, with each screening zones having a different function. This means they have different screening characteristics, and one can filter out smaller particulate matter than the other, i.e. that one is a coarser screen than the other one.

The term “coarse screen”, as used herein, means a screen that comprises gaps in the range of 12 mm to 50 mm in one dimension. Typically, this is achieved by having a screen comprising a number of widely spaced bars. This filters out large particular matter, such as rags and large stones.

As used herein, a “fine screen” comprises a number of apertures (for example circular holes, squares or other shapes), with dimensions in the range of 1 mm to 15 mm in two perpendicular dimensions within the plane of the screening surface. Preferably, a fine screen has apertures in the conveyor screen with dimensions of typically less than 12 mm into those two dimensions, more preferably less than 10 mm. The current standard is typically 6 mm in those two dimensions.

In a system of the invention, there may be one screen, or a plurality of screens. In one embodiment, there are two screens. Each of the screens may have only one screening zone, or it may have a plurality of screening zones.

In a preferred embodiment, a system of the invention contains a single screen, and the system is configured such that the sewage flow passes through the screen only once.

In a more preferred embodiment, a system of the invention contains two screens. Preferably, each screen has a different screening function. For example, one may have a coarser screening function than the other. Preferably, the system is configured such that the sewage flows through each screen in series, i.e. through one screen and then through the other one. Preferably, the sewage flows through each screen in substantially the same direction. This is illustrated by the accompanying drawings which are described in detail below. This “two-pass arrangement” has benefits in terms of minimising hydraulic loss and increasing screening efficiency,

In one embodiment, a system of the invention contains one screen, which has two distinct screening zones. Preferably, the sewage flows through each screening zone in series. Preferably, the sewage flows through each zone in substantially the same direction. This is another example of a “two-pass” system. It will be appreciated that this requires the flow to change direction more than once, and examples of how this may be achieved are illustrated by the drawings.

A screen of the invention may have two coarse screening zones, i.e. two bar screens, but one may have smaller bar spacing than the other one, meaning that they each perform distinct screening functions.

A screen of the invention may have two fine screening zones, i.e. two screens with apertures as defined above. One of those fine screens may have smaller apertures than the other one, meaning that the each perform distinct screening functions.

In a particular preferred embodiment, a screen of the invention comprises a coarse screen and a fine screen.

In a sewage screen of the invention, each of the screenings zones may have a common conveyor movement, e.g. the same mechanism can drive the conveyor movement of the screen.

A tank of the invention is adapted such that the velocity of sewage flow in the tank is less than the velocity of sewage flow in the channel. Preferably, this is achieved by ensuring that the initial (in the direction of flow) cross-sectional flow area in the tank being substantially greater that the cross-sectional flow area in the sewage channel. This is one possible way to decrease the flow velocity in the tank relative to the flow in the channel.

In a preferred embodiment, a tank comprises a channel for inflow, to receive sewage from a channel, and a channel for outflow, to return screened sewage to the channel. Preferably, the inflow and outflow channels have their invert at the same level as the sewage channel, when the tank is in use, i.e. connected to the channel. In a preferred embodiment, a portion of the sewage screen that is contained within the tank is positioned below the invert level of the inflow channel and the invert level of the outlow channel. This portion should have its screening surface in a substantially horizontal plane.

The invention will now be described with reference to the accompanying drawings. The drawings and description of the drawings represent only one embodiment of the invention and are for illustrative purposes only.

A sewage screen of this invention is configured to reduce the hydraulic losses across the screen primarily by reducing the velocity of the flow on the approach and through the screen curtain. Reduction of the velocity is important in two respects: avoidance of kinetic energy losses and extrusion of pliable material through the screen curtain apertures.

In the design of the screen structure, consideration was also given to reducing the kinetic energy of the incoming flow by keeping a bulk of slow-moving water in front of the screen curtain. The design also maximises the distance along the flow path between the entrance and the screen curtain and by so doing, it allows the maximum time for the energy to dissipate and reduces the risk of impact damage by solid matter due to momentum.

The invention comprises one or more screens with a large horizontal surface area contained in a tank or channel.

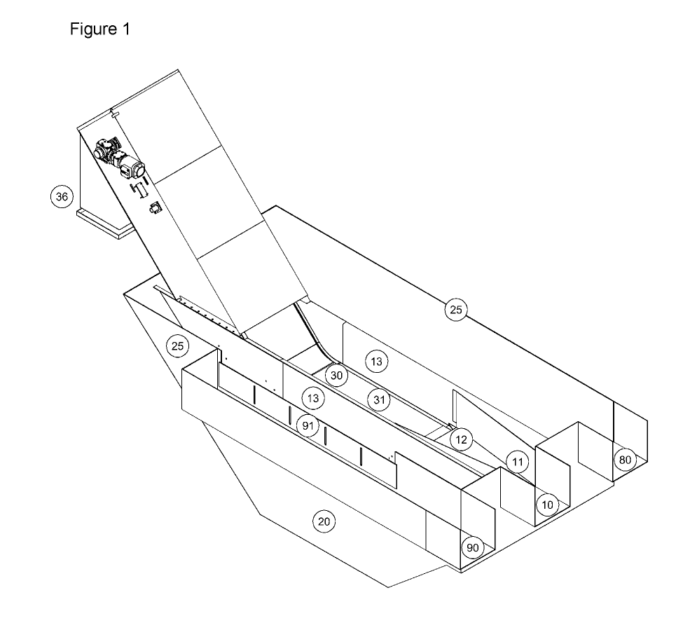

FIG. 1 shows a single screen fitted in a tank. The tank preferentially has a triangular section when viewed from the side, with the waterline in the plane of the longest side of the triangle. The channels shown for inflow (10) and outflow (80) have their invert at the same level. By having the inverts at the same level, the unit is particularly suitable for retro-fitting at any site. The unit can be positioned alongside an existing flow channel. Flow can be diverted out the channel, screened and returned to the original flow path with minimal hydraulic impact.

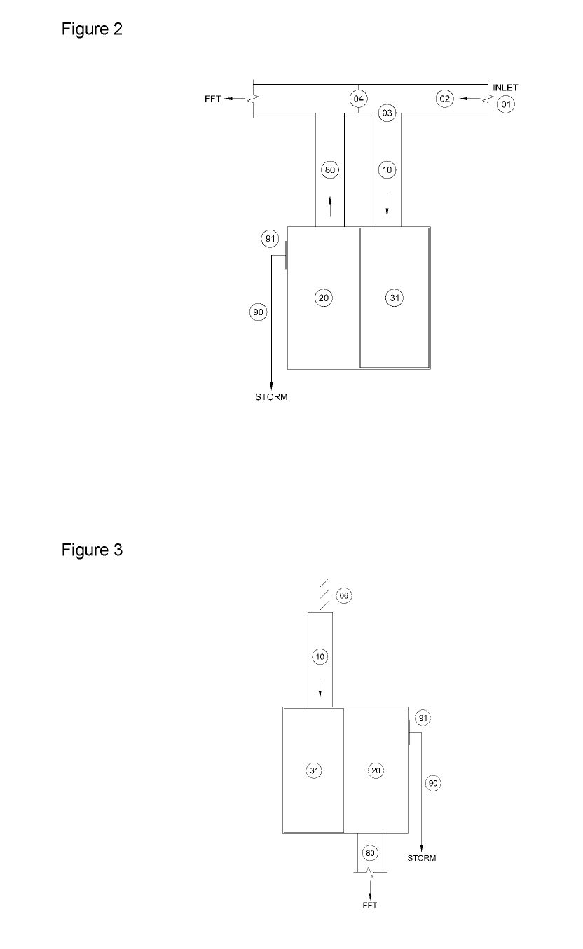

As shown in FIG. 2, the inflow (1) passes along the flow channel (2) and is diverted at a connection point (3) into the new screen unit along inflow channel (10). The original flow path may be fitted with an interruption (4) such as a stop gate or penstock to control the flow movement. Flow isolation (5) may also be incorporated if desired.

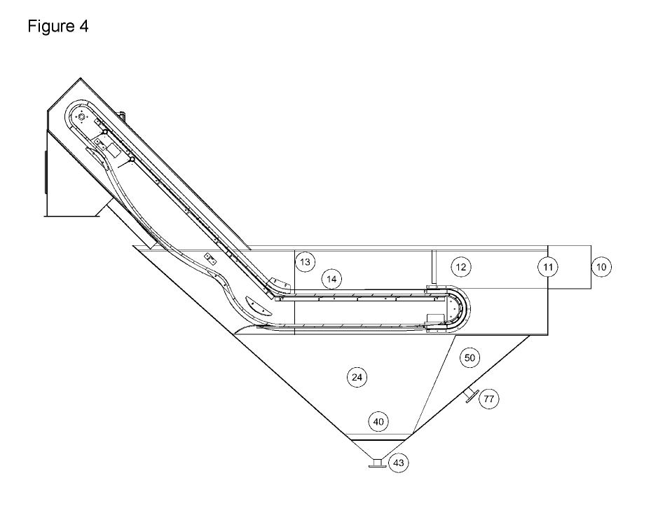

Alternatively, as shown in FIG. 3, the flow from a rising main (6) may be directly connected to the inflow channel (10). The outflow (80) may continue in a forward direction after leaving the unit.

The flow will be screened in a contained zone such as a tank (20) and the flow may then exit by one of two routes. Full Flow to Treatment (FFT) will exit along an outflow channel (80) and rejoin the original flow channel (2) at a point downstream of the interruption (4). The flow will then continue for subsequent treatment. The volume of the tank may provide beneficial flow attenuation of any step changes of inflow rate—such as when a pump starts.

If there is a requirement for storm separation, this can be achieved by incorporating an overflow weir (91) into the tank (20) at some point on the external wall. Storm flow can be taken via a channel (90) or pipe for subsequent storage or discharge.

The arrangement allows for positioning of the outlets in many configurations and, although envisaged for retro-fitting to an existing channel, may also be a beneficial solution for any application with a piped or channel inflow with piped or channel outlets at any orientation to the inflow direction.

When the moving inflow (10) first enters the tank it will have kinetic energy. This energy can be considerable at high flow rates. Large solids carried within the flow can have considerable momentum. To minimise the effect of the momentum, the inflow will preferentially pass through a diffuser zone (12). The diffuser will spread the flow across the available entry width of the screen. Ideally, the diffuser (12) is constructed as part of the screen assembly (30) and is optimally positioned in relation to the screen curtain working surface (31).

The screen assembly (30) comprises of a conveyor system in which the belt curtain (31) which the flow passes through has apertures which can prevent solids over a certain size passing forward. The conveyor action moves and transports the captured screenings out of the flow and away for disposal. In one preferred embodiment, a conveyor such as described in EP1853366 is utilised for the screen curtain, which is incorporated herein by reference.

The screen curtain (31) is positioned such that it is substantially in a horizontal plane and below the waterline where flow enters the screening zone. The tops of any flights (14) on the screen belt (31) are preferentially below the invert level of the diffuser (12) so that any flow entering the tank does not meet any physical resistance.

Because the inflow and outflow invert levels of the tank are the same, when there is no incoming flow the water level in the tank will fall naturally to this invert level. The first flow arriving will start to fill the area above the screen (30). The sidewalls (13) and the diffuser (12) contain the flow. It can only escape through the screen curtain (31). As the flow increases, a bulk of water forms above the screen (14) and it is this bulk of water which acts as a buffer and dissipates the incoming energy of the flow.

In a traditional screen the flow and the solid matter therein are not slowed and impact the screen curtain, whereas in this invention the flow impacts a bulk of water and damage to the screen surface is minimised.

A particular feature is that at higher inflow rates, which may have considerable velocity, a hydraulic jump may be experienced. Hydraulic jump occurs when the kinetic energy of the flow is converted to potential energy. After this point the water moves much slower and the water level is higher. Importantly, the flow downstream of the hydraulic jump and the solids suspended therein has lost most of their forward energy. This has an advantage as the kinetic energy now contained is low and unlikely to extrude pliable material through the screen apertures.

A particular feature of the screen is its large wetted surface area available for the flow to pass through. The wetted area to cross-sectional area (CSA) of the inflow has been factored as follows. First; some definitions:
CSA=(width×height) of the inflow channel
Open area of screen=total area of open apertures (sq.m.) in one square meter of screen curtain (typically 40% to 60%)
Blinding factor=proportion of apertures blocked of by screenings in use (typical factors allowed for in design=25% to 60%)
Other allowances may be made for side-seals, joints etc.

From calculation; the wetted area=CSA×2×(1/open area ratio)×(1/Blinding factor), which in the case of the screen in the invention means that the screen wetted area is at least 4 times, and more typically 8 or more times the CSA.

Peaking factors also have to be allowed for. This factor gives an indication of the rate of arrival of screenings from the catchment and varies from site to site. A peaking factor of 24 (typical) indicates that one day's worth of screenings will arrive in one hour. Factors up to 100 are sometimes required due to the catchment topography.

Peaking does not affect the screens physical pass-through capabilities, but it requires the screen to move and transport screenings deposited away at an appropriate rate to keep the blinding within desired parameters. The screen preferentially will have a variable speed drive allowing it to speed up and clear screenings quicker when the water level above the screen is above a set point.

By virtue of the low velocities through the screen curtain (31), the screenings are gently deposited on the screen curtain for removal. The flights (14) progress the screenings along and also ensure that screenings do not slide back down on the inclined section (35). The large wetted area ensures the flow requires minimal hydraulic head for the flow to pass through the screen curtain.

The flow, having passed downward through the screen curtain, has lost virtually all forward momentum. As a bulk of water (24) it will now naturally form a common water level within the tank, and will rise alongside the screen. The flow will eventually find an exit route at some point on the tanks periphery, where it can outflow. This outflow channel (80) at some point has the similar invert level as the inflow to ensure the bulk of water in the tank is maintained.

In FIG. 2 shown this outlet channel (80) returns back to the original flow channel (2). However, in other applications it could subsequently be piped or channelled away elsewhere for treatment. One example would be as FIG. 3.

The screen is sized to accommodate all incoming flows. At a point when the inflow rate rises above the desired full flow to treatment (FFT) rate, the internal water level of the screened flow in the tank will reach a level above which water can pass over an overflow exit weir (91). This storm weir can be optimally positioned at an orientation independent of the direction of inflow or FFT outflow. In the embodiment shown in FIG. 1, the storm flow can exit along a channel (90). Dependant on the location of any unit, storm flows can be piped or channelled away for storage or discharge.

Screenings removed by the screen are conveyed upwards out of the flow (35) for collection and disposal. The screen can incorporate a cleaning method. In the embodiment shown, one or more spray bars are utilised to wash screenings off the screen curtain.

Grit carried in the inflow will also be separated in this screen arrangement. Grit that is larger than the apertures on the screen curtain (31) will be conveyed away with the screenings. Grit that is smaller than the apertures will pass through and collect under the screen within the containing tank (40).

The low velocities within a screening zone in a system of the invention are a feature which significantly improves the system performance in grit separation equipment, such as that described in EP1075865. Use of a system of the invention enables the volume of the grit settlement tank to be considerably less than in traditional grit separation equipment. Tests have indicated that the volume under the screen should to be minimised to prevent too many fine particulates from settling.

The tank in the invention is preferentially designed so that surfaces where grit or fine particulates could settle are inclined above the slip angle, and are typically greater than 40 degrees from the horizontal.

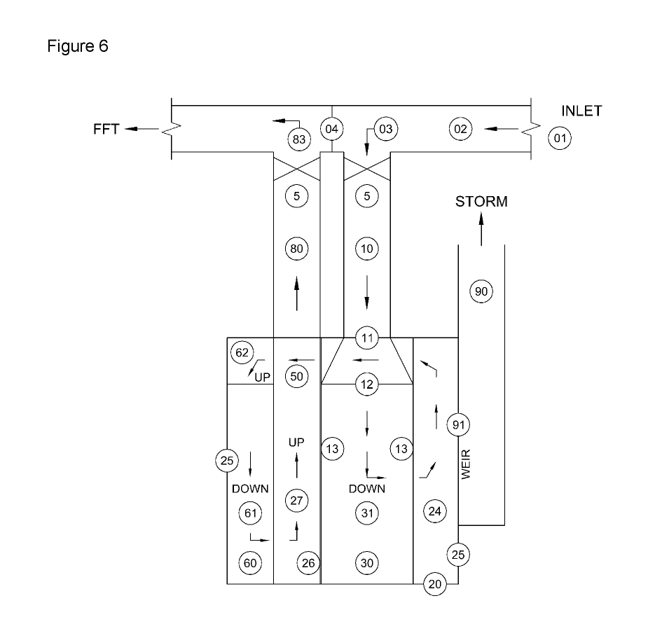

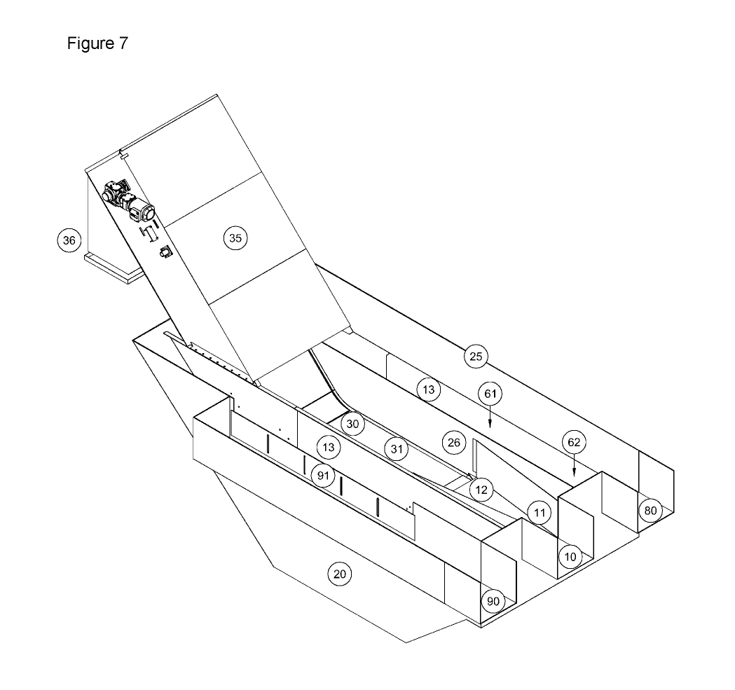

In another preferred embodiment as shown in FIGS. 5 and 6, the tank is divided into a plurality of zones so that staged removal of screenings is made possible. In this embodiment flow that has passed from the first screen is allowed to exit via a transfer (50), an opening in a solid separator between the zones. Preferentially, the transfer is shaped as an inverted pyramid.

In this embodiment, the second screen is preferentially placed in a longitudinally parallel position to the first screen. A transfer (50) directs the flow across horizontally and vertically such that it enters a second screening zone (60). Again, the common invert level of inlet and outlet is maintained. This screening zone is similar to the first, excepting that the inlet flow rises “up a chimney (62)” to reach the start of the second screen surface (61).

By virtue of hydraulic law, the water in the joined sections of the tank will find a common water level, equalising under atmospheric pressure. In practice, the water level in the chimney (62) will be similar to that in the tank surrounding the first screen (24). This level will be higher than the second screen surface so the flow will pass over and through the second screen (61).

The flow passes through the second screen (61) at low velocity in a similar manner to the first pass with screenings and grit being separated. The apertures of the screen curtain in the second pass can be the same or different to that of the first pass. Preferentially, the apertures are largest on the first pass and the apertures on the second pass are sized to take out a further proportion of screenings. This invention allows for any number of screening zones and stages of screenings removal.

In the embodiment shown; after flow has passed through the final screen it can exit the tank along the flow to treatment channel (80). Screened sewage in the outlet zone may be suitable to be used as wash water for the screening system and a flanged outlet may be provided for the wash water draw-off.

In a tank with a plurality of screen zones, there will be a plurality of grit collection points. The grit removal arrangement can be optimised to suit any site. In the embodiment shown, the flanged outlets can be fitted with timer-controlled actuated valves and the grit bled off under hydrostatic pressure to subsequent treatment in an industry standard grit classifier.

In plan view, a unit with a plurality of screens is preferentially asymmetric. As pictured in FIG. 6, the flow entering the first screen is the maximum flow likely to be experienced at any site. The UK Environment Agency defines this flow to be accepted by the treatment works as “Formula A” flow and it approximates to 7 times the Dry Weather Flow (DWF). Typically, the Environment Agency Discharge Consent may only require a Full Flow to Treatment (FFT) of approximately 3 times DWF. The difference is often stored and returned for treatment later.

Therefore, it is preferential to size the first screen pass to accept “Formula A” and the second screen pass for FFT. A width ratio of the two passes of 7:3 is one preferred embodiment.

Alternatively, the second pass screen can be regarded as a “standby screen”, which could potentially handle all the flow in case of emergency. For this case the width ratio would most likely be unity.

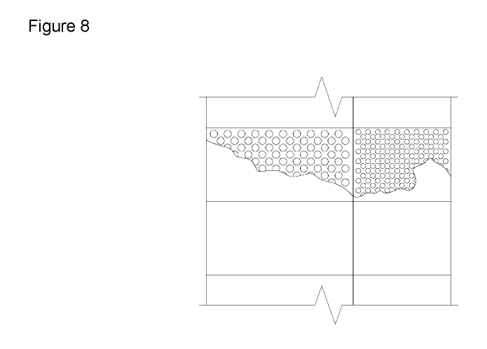

The screens units can be constructed as separate units, as shown. If so aligned, the screens can have a common drive or other shared features. In a further preferred embodiment as shown in FIG. 7, the plurality of screening zones are achieved on a single screen unit by configuring screening modules with different apertures in different areas of a single screen belt.

When a single screen is used for a plurality of passes, the screen curtain has zones where the apertures are sized to achieve the desired screenings removal rate on each pass. Optimally, the removal rate is balanced across the screen curtain, and the final overall screenings capture ratio meets the site requirement.

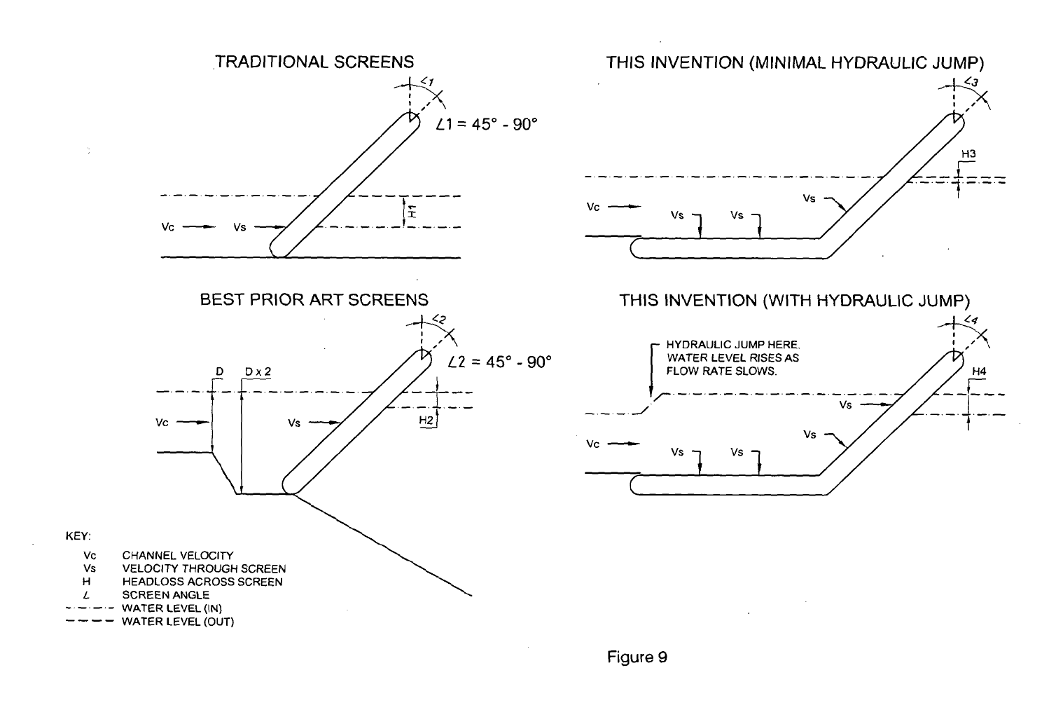

Multiple zones (as shown in FIG. 8) can provide staged removal of screenings to much higher overall removal levels than is possible with traditional screen units in the same dimensional footprint, whilst maintaining minimal hydraulic loss over the unit.

It is envisaged that a screen unit, with its inlet features, is constructed in a factory as an assembly, where it can be optimally aligned and tested prior to installation. Preferentially, it can be easily placed into the tank where it self-locates. Reduced footprint, ease of assembly and common drives assist the reduction of embodied and operational carbon.

The embodiments described are by no means exhaustive and other types of screen and configurations are possible.

The invention will now be illustrated by the following Example.

### EXAMPLE

FIG. 9 shows the elevation of traditional screens of the prior art, and also the elevation of a screen, as it may configured in a system of the invention, i.e. with a substantially horizontal position.

An experiment was conducted to examine the channel velocity, velocity through the screen and head loss across the screen, of each of these screen arrangements, in use. The results are shown below:

| | Vc(m/s) | Vs(m/s) | H (em) |
|---|---|---|---|
| TRADITIONAL | 0.4-1.2 | 0.4-1.2 | 40-60 |
| BEST PRIOR ART | 0.4-1.2 | 0.2-0.6 | 20-30 |
| THIS INVENTION (MINIMAL | 0.4-1.2 | 0.05-0.15 | 2-10 |
| HYDRAULIC JUMP) | | | |
| THIS INVENTION (WITH | 0.4-1.2 | 0.05-0.15 | LOWER |
| HYDRAULIC JUMP) | | | |

### Velocity Advantage at Screen Surface

| | |
|---|---|
| Traditional | V |
| Best prior art | V/2 |
| Invention | V/8 or lower |

### Head Loss Advantage

| | |
|---|---|
| Traditional | H |
| Best prior art | H/2 |
| Invention | H/8 or lower |

The traditional (prior art) screens (such as those identified in EP1075865) still suffer from hydraulic loss, as is evident from the results shown above. Due to their elevation/configuration, they receive a high water impact velocity, which means screen damage from floating solid objects may still occur. Traditional screens (and also the system as shown in EP1075865) have high flow velocity through the holes at higher flow-rates, which can still mean that extrusion of rag through partially blocked holes can occur. This reduces the rag removal efficiency of the screen. They screen will have a tendency to block rapidly when the surge of storm flows hits the screen area, which can cause bypass systems to operate, again reducing screening efficiency.

Further, the screens of the prior art will be difficult to clean and will require high levels of pressure and volume for washwater because the rag material is forced into the holes by the fluid approach velocity and pressure, and hence will need high pressure and volume washwater to provide the cleaning function. This washwater provision is the high energy user for most screening systems. Maintaining high pressure and volume washwater systems is expensive.

A screen of the invention has large area, very low impact velocity, very low water velocity through the screen, lower pressure drop, and hence low likelihood of extruding material into and through holes, so it should be more efficient at rag removal, easier to clean and require lower volume and lower pressure of cleaning water. Hence it should run with significantly lower cleaning power requirements, and hence be a more energy efficient rag removal system. If the washwater can be provided from the outlet of this unit due to its improved rag removal, which is very likely especially with a twin screen function, then energy and equipment savings will be even larger.

The low face impact velocity will also increase the lifetime of the screen and reduce the maintenance requirements as rag and grit material will not be forced onto or between sealing faces. An issue with maintenance of screens is that rag gradually gets forced into these gaps and wear occurs that requires plant shutdowns for seals or contact parts to be replaced. This is especially true where grit is carried in to any seal area with the rag and a grinding paste is formed. A lower maintenance requirement screen would be very useful to the wastewater treatment industry.

### Throughput Advantage on Hydraulic Trials

| | Design | Achieved |
|---|---|---|
| Inlet flow | 50 I/s | 150 I/s |
| Head Loss @ 50 I/s | 10 cm | 2 cm |
| Head Loss @ 150 I/s | Not designed for | 10 cm |

Flow achieved at 3×design flow for the same head loss.

It can be concluded that, when compared to the vertical, substantially vertical or inclined screens of the prior art, which do not have a horizontal portion, a screen of the invention enables there to be a lower velocity at the screen surface, which has a benefit in terms of equipment maintenance (and therefore a benefit to the environment). There is also a head loss advantage, which shows a large benefit to overall throughput.

1. A screening system comprising a tank containing a sewage screen, wherein the tank is configured for attachment to a sewage channel, and to receive sewage flow from an upstream point of the channel, and then to direct the sewage flow through the sewage screen, and then to return the screened sewage flow back into the channel, at a downstream point, or directly to a downstream treatment, and wherein the tank is configured to decrease the velocity of the sewage flow in the tank relative to the channel, such that grit can settle at the bottom of the tank, and wherein the sewage screen comprises a working screening surface, a portion of which lies in a substantially horizontal plane, and is positioned below the invert level of the sewage channel at the upstream point, when in use.

2. The screening system according to claim 1, which comprises at least two sewage screens.

3. The screening system according to claim 2, wherein each sewage screen is adapted to perform a different screening function.

4. The screening system according to claim 1, wherein the sewage screen comprises at least two distinct screening zones, each adapted to perform a different screening function.

5. The screening system according to claim 1, wherein the sewage screen comprises at least two distinct screening zones, wherein one screening zone has a coarser screening function than the other, and wherein the tank is configured such that the sewage flow is directed first through the coarser screen and then through the finer screen.

6. The screening system according to claim 1, wherein the sewage screen is a conveyor screen.

7. The screening system according to claim 2, wherein each sewage screen comprises at least two distinct screening zones, each adapted to perform a different screening function, and wherein the screening system is configured such that the sewage flow passes through each screen or each screening zone in substantially the same direction.

8. The screening system according to claim 1, wherein the screen's proximity to or engagement with the inlet channel forms an underwater seal.

9. A sewage screen suitable for use in a screening system according to claim 1, which comprises means for inducing and controlling a conveyor movement of the screen, and which comprises a plurality of screening zones, wherein each screening zone has a different screening function.

10. The sewage screen according to claim 9, wherein one of the screening zones comprises a coarse screen, which comprises a number of parallel bars positioned with a gap between adjacent bars.

11. The sewage screen according to claim 10, wherein each gap is less than 5 cm wide.

12. The sewage screen according to claim 9, wherein one of the screening zones comprises a fine screen, which comprises a number of holes, each hole having a cross-sectional surface area of less than 5 cm², in the plane of the screen.

13. The sewage screen according to claim 9, which is divided into at least two longitudinally arranged screening zones.

14. The sewage screen according to claim 9, which comprises two planar rectangular sections, joined together at their ends by a curved section.

15. A tank, suitable for use in a system according to claim 1 and which is configured for attachment to a sewage channel, and configured to receive sewage flow from an upstream point of the channel, and then to return the sewage flow back into the channel, at a downstream point, or to downstream treatment, wherein the tank is configured to decrease the velocity of the sewage flow in the tank relative to the channel, such that grit can settle at the bottom of the tank, and wherein the tank is configured such that sewage flows in at least two substantially opposite directions inside the tank.

16. The tank according to claim 15, wherein the floor of the tank is angled such that grit can collect in a corner of the tank.

17. A method of screening sewage that flows in a sewage channel, comprising diverting the sewage flow from the channel into a tank or system, which is configured such that the velocity of the sewage flow is lowered and grit can settle at the bottom of the tank, wherein large particulate matter is removed by a screen situated in the tank, wherein at least part of the screening surface of the screen is in a substantially horizontal plane and positioned below the invert level of the sewage channel.

18. The method according to claim 17, wherein there is a plurality of screening zones within the tank, each screening zone providing a different screening function.

19. The method according to claim 18, wherein the screening zones provide a progressively finer screening function, in the direction of sewage flow.

20. The method according to claim 17, wherein the tank or system is as described in any preceding claim.
